(19) United States
(12) Patent Application Publication
(10) Pub. No.: US 2012/0290780 A1
(43) Pub. Date: Nov. 15, 2012

(54) Multithreaded Operation of A Microprocessor Cache

(75) Inventors: Ryan C. Kinter, Seattle, WA (US); Thomas Benjamin Berg, Portland, OR (US); Matthias Knoth, San Jose, CA (US)

(73) Assignee: MIPS Technologies Inc., Sunnyvale, CA (US)

(21) Appl. No.: 13/360,319

(22) Filed: Jan. 27, 2012

Related U.S. Application Data
(60) Provisional application No. 61/436,931, filed on Jan. 27, 2011.

(51) Int. Cl. G06F 12/08; G06F 12/00

(52) U.S. Cl. 711/104; 711/120; 711/E12.001; 711/E12.055

(57) ABSTRACT

A method of fetching data from a cache begins by preparing to fetch a first set of cache ways for a first data word of a first cache line a using a first thread. Next, in parallel, a second set cache ways for a first data word of a second cache line is prepared to be fetched using a second thread, and data associated with each cache way of the first set of cache ways are fetched using the first thread. Also performed in parallel, data associated with each cache way of the second set of cache ways is fetched using the second thread and a third set of cache ways for a second data word of the first cache line is prepared to be fetched using the first thread based on a selected cache way, the selected cache way selected from the first set of cache ways.

### CROSS REFERENCE TO RELATED APPLICATIONS

This patent application claims the benefit of U.S. Provisional Patent Application No. 61/436,931 filed on Jan. 27, 2011, entitled “Power Reduction instruction Cache in a Multi-Thread Processor Core,” which is incorporated by reference herein in its entirety.

### BACKGROUND

1. Field of the Invention

The invention is generally related to microprocessors.

2. Related Art

An instruction fetch unit of a microprocessor is responsible for continually providing the next appropriate instruction to the execution unit of the microprocessor. A conventional instruction fetch unit typically employs a large instruction cache that is always enabled in order to provide instructions to the execution unit as quickly as possible. While conventional fetch units work for their intended purpose, they consume a significant amount of the total power of a microprocessor. This makes microprocessors having conventional fetch units undesirable and/or impractical for many applications.

### BRIEF SUMMARY OF THE INVENTION

An embodiment provides a method of fetching data from a cache. The method begins by preparing to fetch a first set of one or more cache ways for a first data word of a first cache line a using a first microprocessor thread. Next, in parallel, a second set of one or more cache ways for a first data word of a second cache line is prepared to be fetched using a second microprocessor thread, and data associated with each cache way of the first set of cache ways are fetched using the first microprocessor thread. Also performed in parallel, data associated with each cache way of the second set of cache ways is fetched using the second microprocessor thread and a third set of one or more cache ways for a second data word of the first cache line is prepared to be fetched using the first microprocessor thread. Preparing to fetch the third set of one or more cache ways is based on a selected cache way, the selected cache way selected from the first set of cache ways by the first microprocessor thread.

A system for fetching data from a cache is also provided. The system includes a multiway instruction cache configured to perform the following: preparing to fetch a first set of one or more cache ways for a first data word of a first cache line a using a first microprocessor thread. Next, in parallel, a second set of one or more cache ways for a first data word of a second cache line is prepared to be fetched using a second microprocessor thread, and data associated with each cache way of the first set of cache ways are fetched using the first microprocessor thread. Also performed in parallel, data associated with each cache way of the second set of cache ways is fetched using the second microprocessor thread and a third set of one or more cache ways for a second data word of the first cache line is prepared to be fetched using the first microprocessor thread. Preparing to fetch the third set of one or more cache ways is based on a selected cache way, the selected cache way selected from the first set of cache ways by the first microprocessor thread.

### BRIEF DESCRIPTION OF THE DRAWINGS/FIGURES

The accompanying drawings, which are incorporated herein and form part of the specification, illustrate the present invention and, together with the description, farther serve to explain the principles of the invention and to enable a person skilled in the pertinent art to make and use the invention.

FIG. 1 shows a microprocessor having a multiway instruction cache.

FIG. 2 shows a more detailed view of a multiway instruction cache, according to an embodiment.

FIG. 3 shows an instruction cache, according to an embodiment.

FIG. 4 shows a table illustrating the operation of a multiway instruction cache, according to an embodiment.

FIG. 5 shows a multithreaded multiway instruction cache, according to an embodiment.

FIG. 6 shows a table illustrating the operation of a multithreaded multiway instruction cache, according to an embodiment.

FIG. 7 shows a table illustrating the operation of a multithreaded serialized multiway instruction cache, according to an embodiment.

FIG. 8 shows a flowchart illustrating a method of fetching data from a cache, according to an embodiment.

FIG. 9 shows a partial address micro-tag array, according to an embodiment.

Features and advantages of the invention will become more apparent from the detailed description of embodiments of the invention set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION

The following detailed description of embodiments of the invention refers to the accompanying drawings that illustrate exemplary embodiments. Embodiments described herein relate to a low power multiprocessor. Other embodiments are possible, and modifications can be made to the embodiments within the spirit and scope of this description. Therefore, the detailed description is not meant to limit the embodiments described below.

It should be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

### Processor Core

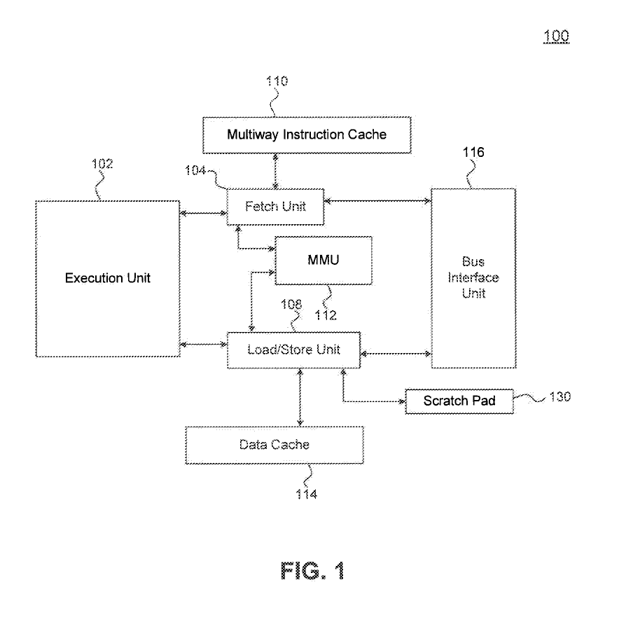

FIG. 1 is a diagram of a processor core 100 according to an embodiment of the present invention. As shown in FIG. 1, processor core 100 includes an execution unit 102, a fetch unit 104, a load/store unit 108, a memory management unit (MMU) 112, a multiway instruction cache 110, an data cache 114 and a bus interface unit 116. While processor core 100 is described herein as including several separate components, many of these components are optional components that will not be present in each embodiment of the present invention, or components that may be combined, for example, so that the functionality of two components reside within a single component. Thus, the individual components shown in FIG. 1 are illustrative and not intended to limit the present invention.

Execution unit 102 preferably implements a load-store (RISC) architecture with single-cycle arithmetic logic unit operations (e.g., logical, shift, add, subtract, etc.). In one embodiment, execution unit 102 includes 32-bit general purpose registers (not shown) used for scalar integer operations and address calculations. Optionally, one or more additional register file sets can be included to minimize content switching overhead, for example, during interrupt and/or exception processing. Execution unit 102 interfaces with fetch unit 104 and load/store unit 108.

Fetch unit 104 provides instructions to execution unit 102. In one embodiment, fetch unit 104 includes control logic for multiway instruction cache 110, a recorder for recoding compressed format instructions, dynamic branch prediction, an instruction buffer to decouple operation of fetch unit 104 from execution unit 102, and an interface to a scratch pad 130. Fetch unit 104 interfaces with execution unit 102, memory management unit 112, multiway instruction cache 110, and bus interface unit 116.

As used herein, a scratch pad 130 is a memory that provides instructions that are mapped to one or more specific regions of an instruction address space. The one or more specific address regions of a scratch pad 130 may be pre-configured or configured programmatically while the microprocessor is running. An address region is a continuous range of addresses that may be specified, for example, by a base address and a region size. When base address and region size are used, the base address specifies the start of the address region and the region size, for example, is added to the base address to specify the end of the address region. Once an address region is specified for a scratch pad 130, all instructions corresponding to the specified address region are retrieved from the scratch pad 130.

Load/store unit 108 performs data loads and stores, and includes data cache control logic. Load/store unit 108 interfaces with data cache 114 and other memory such as, for example, a scratch pad 130 and/or a fill buffer (not shown). Load/store unit 108 also interfaces with memory management unit 112 and bus interface unit 116.

Memory management unit 112 translates virtual addresses to physical addresses for memory access. In one embodiment, memory management unit 112 includes a translation lookaside buffer (TLB) and may include a separate instruction TLB and a separate data TLB. Memory management unit 112 interfaces with fetch unit 104 and load/store unit 108.

Multiway instruction cache 110 is an on-chip memory array organized as a multi-way set associative cache such as, for example, a 2-way set associative cache, a 4-way set associative cache, an 8-way set associative cache, et cetera. Multiway instruction cache 110 is preferably virtually indexed and physically tagged, thereby allowing virtual-to-physical address translations to occur in parallel with cache accesses. In one embodiment, the tags include a valid bit and optional parity bits in addition to physical address bits. As described in more detail below, it is a feature of the present invention that components of multiway instruction cache 110 can be selectively enabled and disabled to reduce the total power consumed by processor core 100. Multiway instruction cache 110 interfaces with fetch unit 104.

Data cache 114 is also an on-chip memory array. Data cache 114 is preferably virtually indexed and physically tagged. In one embodiment, the tags include a valid bit and optional parity bits in addition to physical address bits. Data cache 114 interfaces with load/store unit 108.

Bus interface unit 116 controls external interface signals for processor core 100. In one embodiment, bus interface unit 116 includes a collapsing write buffer used to merge write-through transactions and gather writes from uncached stores.

### Multiway Instruction Cache 110

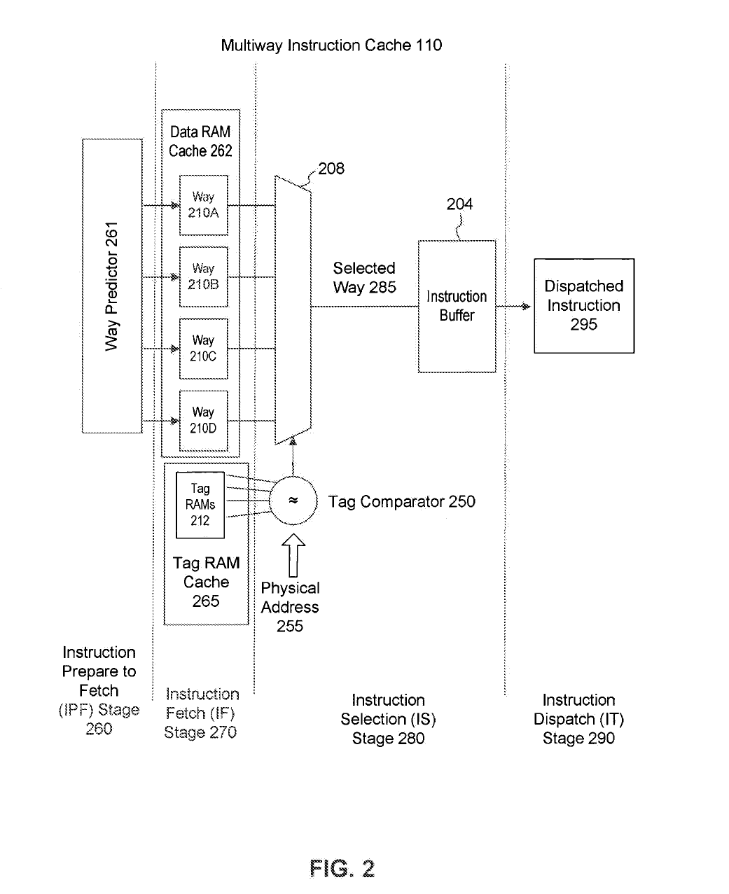

To illustrate aspects of embodiments, FIG. 2 shows a multiway instruction cache 110 using data ways 210A-D in data RAM cache 262 and tag RAMs 212 in tag RAM cache 265. Multiway instruction cache 110 includes components used in four stages: instruction prepare to fetch stage (IPF) 260, instruction fetch stage (IF) 270, instruction selection stage (IS) 280 and instruction dispatch stage (IT) 290. During IPF stage 260 preparations are made to fetch specific RAMs from data RAM cache 262 for ways 210A-D during IF stage 270. Such preparations may include accessing way predictor 261 to identify ways 210A-D in data RAM cache 262. IF stage 270 includes ways 210A-D accessed from a data RAM cache 262 and tag RAMs 212 from tag RAM cache 265. IS stage 280 includes way selector 208 coupled to tag comparator 250 and instruction buffer 204. Tag comparator 250 receives physical address 255. Way selector 208 provides selected way 285 to instruction buffer 204. IT stage 290 includes dispatched instruction 295 from instruction buffer 204.

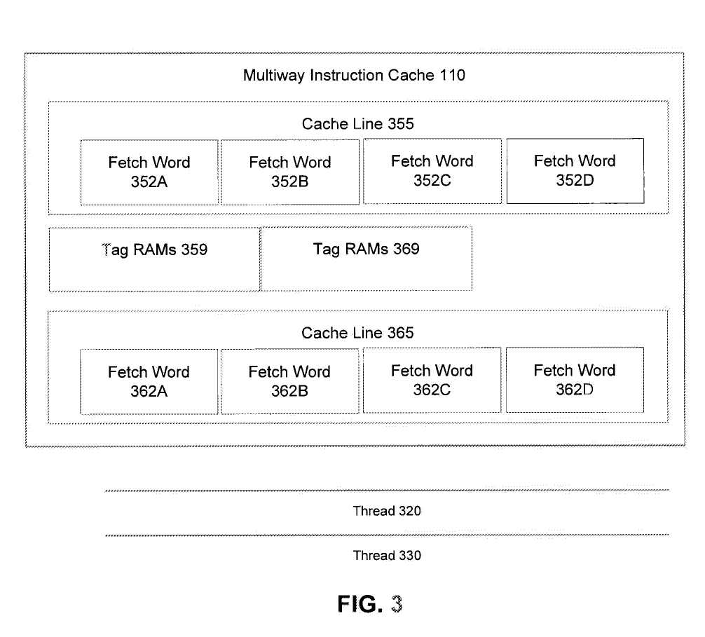

The following is intended to be a brief description of the different stages shown in FIG. 2. As would be appreciated by one having skill in the relevant art(s), given the description herein, in multiway instruction cache 110, these phases are part of a pipelined structure to: provide a fetch address, access ways 210A-D, select a suitable cache way 210A-D and store selected instructions from the selected way 285 inside instruction buffer 204. These stages are referenced below with the description of FIGS. 3-7 and some embodiments described herein. An example of a similar multiway cache using similar phases is described in U.S. Pat. No. 7,562,191 ('191 patent) filed on Nov. 15, 2005, and issued on Jul. 14, 2009, entitled “Microprocessor Having a Power Saving Instruction Cache Way Predictor and Instruction Replacement Scheme” which is incorporated by reference herein in its entirety, although the invention is not limited to this example.

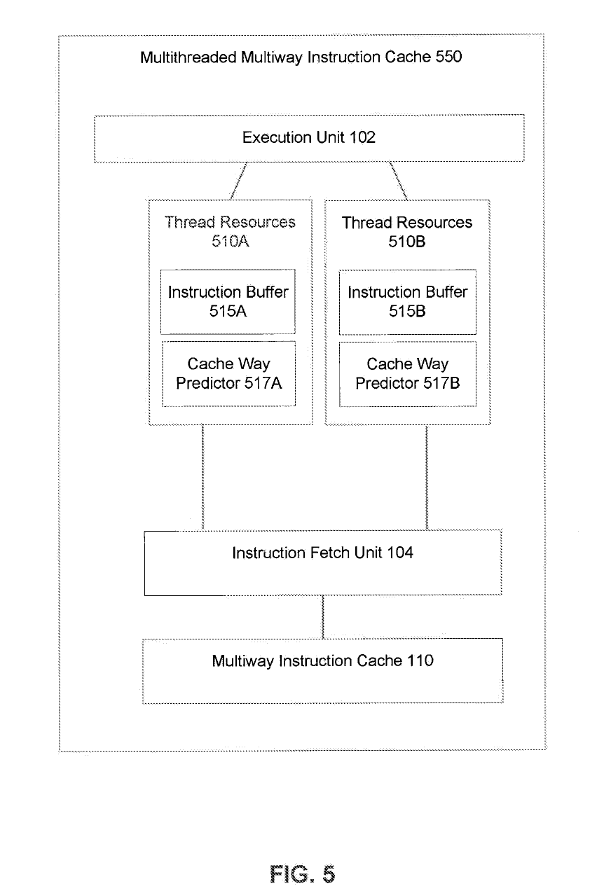

As would be appreciated by one having skill in the relevant art(s), given the description herein, the following list describes phases used by multiway instruction cache 110. In embodiments described with reference to FIGS. 5-8 below, these phases will be referenced and described with other embodiment features. An exemplary embodiment described herein involves fetching instructions from an instruction cache. One having skill in the relevant art(s), given the description herein, would appreciate that different features of embodiments described herein can be applied to retrieving data from a data cache as well.

Instruction Prepare to Fetch (IPF) Stage 260

As would be appreciated by one having skill in the relevant art(s), given the description herein, in IPF stage 260, several operations are performed to prepare for fetching an instruction from data RAM cache 262. These operations include accessing a cache way predictor 261 to determine which ways 210A-D of data RAM cache 262 to prepare for fetching. The results of this stage are an address and control signals being presented to the instruction cache RAM arrays. As used herein, preparing to fetch an instruction can also be termed “enabling” the instruction.

As described in the '191 patent, a multi way instruction cache can use tag RAMs 212 from tag RAM cache 265 to store the physical address for tag comparison to select the applicable cache way.

As noted above, way prediction is performed at the instruction prepare to fetch (IPF) stage. In IPF stage 260, way predictor 261 is used select instructions to enable to be fetched in IF stage 270. Each enabled instruction becomes a cache way 210A-D to be fetched during IF stage 270. Information that improves way prediction is used at this stage. The more accurate the way prediction, the fewer ways 210A-D need to be fetched during the IF stage 270.

Parallel access of all way data RAMs and tag RAMs achieves highest performance but because a large amount of extra data is retrieved, parallel access also requires the highest access energy of the approaches discussed herein.

Instruction Fetch (IF) Stage 270

In IF stage 270, the retrieval of tag RAMs 212 and one or more enabled data ways 210A-D causes multiway instruction cache 110 to expend energy. For example, to increase performance and reduce the likelihood of a cache mis-predict, in one approach to implementing multiway instruction cache 110, in parallel, all four way 210A-D data RAMs are accessed with cache tag RAMs 212 and during IF stage 270. As compared to embodiments described herein, this approach expends a large amount of energy.

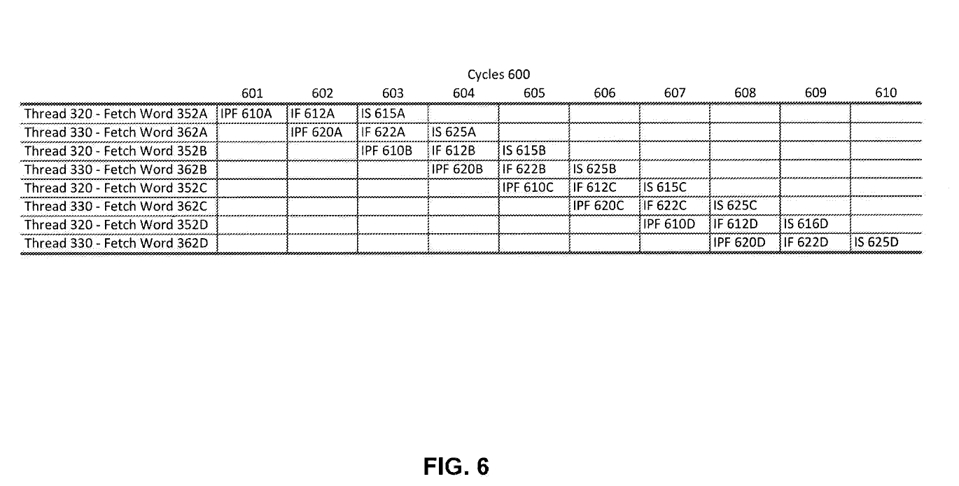

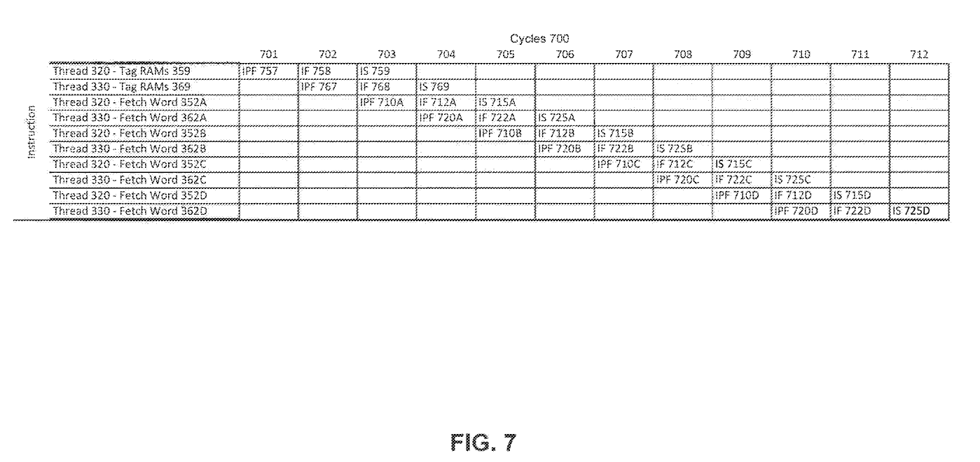

Reducing the quantity of ways 210A-D and tag RAMs 212 that are retrieved at this IF stage can reduce the power expended by multiway instruction cache 110. In embodiments described below with the description of FIGS. 6 and 7, improved way prediction results in a reduction in power expended during IF stage 270.

Instruction Selection (IS) Stage

After tag comparison completes, the applicable cache way is selected. Physical address 255 is received at tag comparator 250. Physical address 255 is compared to fetched tag RAMs 212, and one of the fetched cache ways 210A-D is selected by way selector 208 and forwarded as selected way 285 to instruction buffer 204.

Dispatch (IT) Stage

As would be appreciated by one having skill in the relevant art(s), given the description herein, in IT stage 290 an instruction stored in instruction buffer 204 is dispatched, as dispatched instruction 295, to execution unit 102 for execution. Embodiments described herein relate to populating instruction buffer 204 with instructions, an IT stage 290 is not discussed.

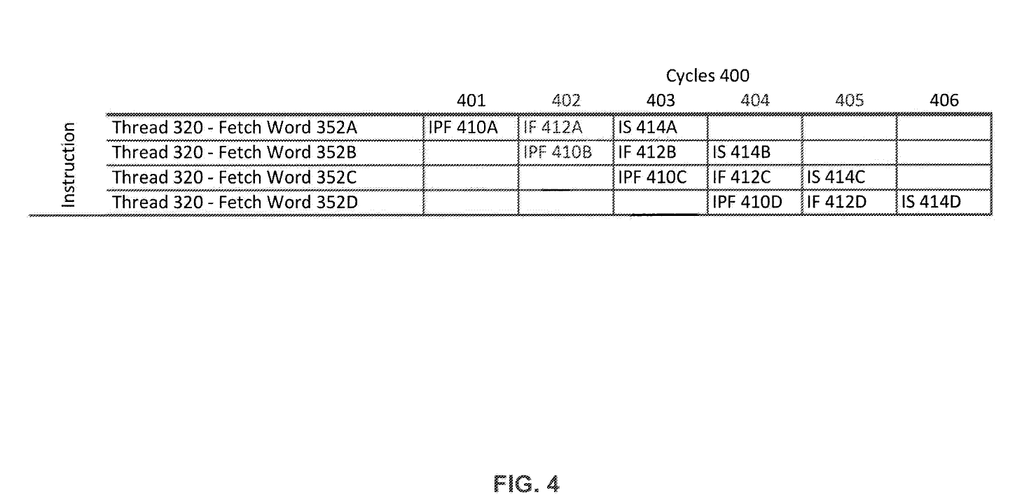

FIG. 3 shows a more detailed view of multiway instruction cache 110 that is used in the descriptions of embodiments shown in FIGS. 4, 6 and 7. Multiway instruction cache 110 includes caches lines 355 and 365 and tag RAMs 359, 369. Cache lines 355 and 365 include fetch words 352A-D and 362A-D respectively. Tag RAMs 359 are associated with cache line 355 and tag RAMs 369 are associated with cache line 365.

Embodiments described herein use way prediction. Way prediction can be based on known characteristics of the data as cached. These known characteristics allow for a prediction of the placement of a fetch word based on the location of a previously fetched word. For example, as shown in FIG. 3, fetch words 352A-D, 362A-D are stored sequentially in respective cache lines 355, 365. In an example, way prediction can be used to predict the location of fetch word 352B based on the placement of fetched fetch word 352A—if known at the appropriate time.

In addition, it would be appreciated by one having skill in the relevant art(s), given the description herein, that way prediction can rely on other conditions. For example, writes to cache lines 355, 365 may have to be monitored to ensure that prior tag states stored in tag RAM cache 265 are still valid.

FIG. 3 also shows threads 320 and 330. As used herein, the term “thread” typically refers to aspects of a multiprogramming technique whereby a processing device or devices operate concurrently on system tasks. One skilled in the relevant art(s), having access to the teachings herein, will understand that a thread can describe processes, workers, fibers, protothreads, and other variations associated with processing concurrency.

FIG. 4 is a table that shows cycles 401-406 in the operation of multiway instruction cache 110. During each cycle, one or more of the stages (IPF, IF, IS) are performed on one or more fetch words 352A-D by thread 320.

Cycles 401-406 are described below:

Cycle 401: In this cycle, IPF 410A, ways 210A-D are enabled as ways to access fetch word 352A. Cache ways 210A-D and tag RAMs 212 associated with ways 210A-D are enabled for fetching in IF 412A. As described with cycles 402-406 below, the approach described with FIG. 4 is based on 100% activity in the first fetch access, with all associated tag RAMs 212 and way data RAMs 210A-D enabled at IPF stage 260. Once the first way calculation completes in cycle 403, access energy saving features are enabled.

Cycle 402: In this cycle, IF 412A, tag RAMs 212 associated with selecting ways 210A-D and ways 210A-D are fetched. At this cycle, because all of the associated tag RAMs and ways 210A-D are fetched, power expended at this phase can be termed as 100% of the possible access energy expenditure for a non-way predicted approach (hereinafter “possible access energy expenditure”). It should be noted that, as used herein, estimates of possible access energy expenditure are based on the following values: assuming four cache ways 210A-D can be fetched, each cache way uses 20% of the possible access energy expenditure. Retrieving tag RAMs 212 associated with the cache ways uses an additional 20% of the possible access energy expenditure. One having skill in the relevant art(s), given the description herein will appreciate that estimating access energy can be based on different values and factors.

This fetching of tag RAMs 212 and ways at the same time is termed “parallel fetching.” Also, in this cycle, in IPF 410B, similar to cycle 401 above, cache ways 210A-D are enabled as ways to access fetch word 352B.

Cycle 403: In this cycle, IS 414A, physical address 255 associated with fetch word 352A is received at tag comparator 250. Tag comparator 250 compares received physical address 255 with tag RAMs 212 to select one of ways 210A-D. The data retrieved with selected way 285 are forwarded to instruction buffer 204. In one approach, selected way 285 can improve way prediction during the IPF stage of other fetch words in cache line 355. Because ways associated with fetch word 352D have already been predicted in IPF 410B of cycle 402, selected way 285 does not improve this prediction. Like IF 412A described above, because selected way 285 was not available at cycle 402 for IPF 410B, IF 412B uses 100% possible access energy expenditure.

In IPF 410C however, for fetch word 352C, selected way 285 improves way prediction. Selected way 285 information reduces the amount of data that is enabled during IPF 410C for fetch word 352C. In some circumstances, selected way 285 allows for only a single way 210A to be enabled for fetching at this stage.

In addition, because selected way 285 is available, only one way needs to be enabled, and tag RAMs 212 do to not need to be retrieved to select from multiple retrieved ways. This reduction in the amount of data fetched results in a power savings for fetching associated with fetch word 352C in cycle 404, IF 412C.

Finally, in IS 414A, the data retrieved with selected way 285 for fetch word 352A is forwarded to instruction buffer 204.

Cycle 404: In IPF 410D, similar to IPF 410C above, for fetch word 352D, selected way 285 improves way prediction. This way information reduces the amount of data that is enabled during IPF 410D. Selected way 285 allows for only a single way 210A to be enabled for fetching at this stage. In addition, because selected way 285 is available, only one way needs to be enabled, and tag RAMs 212 do to not need to be retrieved to select from multiple retrieved ways. This will result in a power savings for fetching associated with fetch word 352D in cycle 405, IF 412D.

As noted in cycle 403 above, during cycle 404, in IF 412C, enabled by way 210A is fetched. This fetch of a single predicted way 210A uses less power than IF 412A described with cycle 402 above. Because tag RAMs are not retrieved and only a single predicted way is retrieved, based on the estimate calculation outlined above, access energy expended by this stage is estimated at 20% of the possible access energy expenditure.

Also in this cycle, at IS 414B, fetch word 352B is selected and forwarded to instruction buffer 204.

Cycle 405: As noted in cycle 404 above, during cycle 405, in IF 412D, enabled by way 210A is fetched. This fetch of a single predicted way uses power similar to than IF 412C described with cycle 404 above. Because tag RAMs are also not retrieved and only a single predicted way is retrieved, power expended by this stage is estimated at 20% of the possible access energy expenditure.

Also in this cycle, at IS 414C, fetch word 352C is selected and forwarded to instruction buffer 204.

Cycle 406: In this cycle, at IS 414D, fetch word 352D is selected and forwarded to instruction buffer 204.

As described with cycles 401-406 above, a pipelined structure to provide a fetch address, access the cache RAMs, select a suitable cache way and store selected instructions inside an instruction buffer has inherent latencies before a way selection is calculated. Selected way 285 was not determined until cycle 403, and only improved way selection for fetch words 352C-D. Until the first way calculation completes access all tag and way RAMs are accessed until the first way calculation completes, e.g., for fetch words 352A-B.

Because fetch words 352A-B used 100% access energy and fetch words 352C-D used 20% access energy, the aggregate access energy estimate for this approach is 60% of the maximum possible expenditure.

### Multithreaded Operation of a Fetch Unit

FIG. 5 shows multithreaded multiway instruction cache 550, according to an embodiment. Multithreaded multiway instruction cache 550 includes execution unit 102 coupled to thread resources 510A-B. Instruction fetch unit 104 is coupled to multiway instruction cache 110. Thread resources 510A-B respectively include instruction buffers 515A-B and cache way predictors 517A-B.

The example in FIG. 3 above uses a pipelined structure to provide a fetch address, access the cache tag RAMs and data RAMs, select a suitable cache way 210A-D and store selected way 285 instructions inside instruction buffer 204. In an embodiment, to reduce latencies and access power expenditure, an embodiment uses multithreaded operation of the fetch unit 104.

As described with reference to FIGS. 5-7 below, a multithreaded multiway instruction cache having a sufficient number of interleaved threads processing independent address ranges and access requests can ensure that only one fetch request is in flight within the fetch pipeline until a way selection of a thread is calculated. Thereafter, the same thread—now having a selected data RAM cache way, can proceed, requesting further fetches without requiring the fetching of tag RAMs 359, 369 and additional ways.

In an example shown on FIG. 5, thread resources 510A-B are used by respective threads 320, 330 operated on by fetch unit 104. Each thread stores fetched instructions in a separate instruction buffer 515A-B. In this approach, because each thread 320, 330 has a separate instruction buffer 515A-B, instruction fetch unit 104 can be working fill up each instruction buffer 515A-B, and execution unit 102 can select instructions from the instruction buffers 515A-B.

Rather than a single thread of execution being in each stage, thread stages (IPF 260, IF 270, IS 280) are interleaved between two threads 320 and 330. In an embodiment, as described with reference to FIG. 6 below, because of this interleaving, the number of fetches performed without way selection information is reduced, and thus overall power consumption is reduced.

FIG. 6 is a table that shows cycles 601-610 in the operation of multithreaded multiway instruction cache 550. During each cycle, one or more of the stages (IPF 260, IF 270, IS 280) are performed on one or more fetch words 352A-D and 362A-D by interleaved operation of threads 320 and 330. Though the embodiment shown uses two threads (320, 330), this example is intended to be non-limiting, and additional threads can also be used with the stages and techniques shown. In addition, though each stage (IPF 260, IF 270, IS 280) are shown in FIGS. 4, 6 and 7 as being completed in a single cycle, different embodiments can have stages that span multiple cycles.

With multithreaded operation of fetch unit 104, each thread processes independent address ranges and access requests. For example, as shown in FIG. 6, with thread resource 510A, thread 320 stores fetch words 352A-D from cache line 355 in instruction buffer 515A. With thread resource 510B, thread 330 stores fetch words 362A-D from cache line 365 in instruction buffer 515B. Instruction fetch unit 104 selects instructions to execute from both instruction buffers 515A-B.

Cycle 601: In this cycle, IPF 610A, ways 210A-D are enabled as ways to access fetch word 352A. Because of this, ways 210A-D and tag RAMs associated with ways 210A-D are enabled for fetching in IF 612A. As with cycles 400 described with FIG. 4 above, 100% activity is enabled in the first IPF performed for fetch word 352A (IPF 610A), with all associated tag RAMs 212 and way data RAMs 210A-D enabled for fetching at IF 612A. Changes between cycles 400 described with FIG. 4, and cycles 600 described with FIG. 6 are described starting with cycle 603 below.

Cycle 602: In this cycle, IF 612A using thread 320, the enabled tag RAMs 212 associated with selecting ways 210A-D and ways 210A-D are fetched. As with cycle 402 above, because all of the associated tag RAMs and ways 210A-D are fetched, power expended is 100% of the possible access energy expenditure. As in cycle 402 above, in this embodiment of multithreaded multiway instruction cache 550, when required, tag RAMs 212 and data RAMs are still parallel fetched.

In contrast to cycles 400 from FIG. 4 above, instead of preparing to fetch tag and data RAMs associated with fetch word 352B, thread 330, IPF 620A enables all tag RAMs 369 and ways 210A-D associated with fetch word 362A. This is an example of the interleaved, multithreaded approach used by some embodiments.

Cycle 603: In this cycle, IS 615A using thread 320, a physical address 255 associated with fetch word 352A is received at tag comparator 250. Tag comparator 250 compares received physical address 255 with tag RAMs 359 to select one of ways 210A-D. The data retrieved with selected way 285 are forwarded to the instruction buffer 515A associated with thread 320. In one approach, as noted with cycle 403 above, selected way 285 can improve way prediction during the IPF stage of other fetch words in same cache line.

Unlike cycle 403 above, where ways associated with fetch word 352B are not yet predicted, at cycle 603, selected way 285 can improve this prediction and reduce the access energy required to fetch fetch word 352B. Thus, in IPF 610B, based on selected way 285, thread 320 only enables a single data RAM and does not retrieve tag RAMs 359. It should be noted that, in cycle 602, interleaving in IPF 620A by thread 330 caused a delay that allowed selected way 285 to be generated in time for IPF 610B of fetch word 352B.

In IF 622A, thread 330 fetches enabled tag RAMs 212 and data RAMs associated with fetch word 362A. Similar to cycle 602, in the first IPF stage performed associated with fetch word 362A, all associated tag RAMs 212 and data RAMs are enabled. Thus, IF 622A, like IF 612A for fetch word 352A, uses 100% of the possible access energy expenditure.

Cycle 604: In this cycle, in IS 625A using thread 330, a physical address 255 associated with fetch word 362A is received at tag comparator 250. Tag comparator 250 compares received physical address 255 with tag RAMs 212 to select one of ways 210A-D. The data retrieved with selected way 285 are forwarded to the instruction buffer 515B associated with thread 330. As noted herein, this selected way 285 will assist with performing IPF stages associated with the same thread 330.

Thus, in IPF 620B, based on selected way 285 from IS 625A, for fetch word 362B, thread 330 only enables a single data RAM and does not retrieve tag RAMs 212. As with thread 320 in cycle 602, interleaving threads 320, 330 in causes a delay that allows selected way 285 to be generated in time for IPF 620B for fetch word 362B.

In IF 6128, using thread 320, the enabled way associated with fetch word 352B from IPF 610B is fetched. As noted in cycle 603 above, because selected way 285 was available for IPF 610B, IF 612B only needs to fetch a single way and no tag RAMs 212. Thus, in contrast to cycle 602 described above, fetching fetch word 352B in cycle 604 IF 612B is estimated to use 20% of possible access energy expenditure as compared to 100% in IF 612A of cycle 602.

Cycles 605 through 610: As would be appreciated by one having skill in the relevant art(s), given the description herein, as shown on FIG. 6, the remaining fetch words 352B-D and 362 B-D are processed by threads 320 and 330. It should be noted that, the 20% possible access energy expenditure associated with IF 622B, IF 612C, IF 622C, IF 612D and IF 622D results in an aggregate possible access energy expenditure of 40% for retrieving both cache lines 355 and 365 in ten (10) cycles (five (5) cycles per cache line) as compared to access power expenditure associated with a non way predicted approach. This can be compared to cycles 400, where a single cache line is fetched in six (6) cycles with a 60% possible access energy expenditure. Thus, the embodiment described with FIG. 6 results in one (1) fewer cycle per cache line fetch, and 33% less energy expended than the non multithreaded approach described in FIG. 4.

### Multithreaded, Serialized Operation of a Fetch Unit

FIG. 7 shows a multithreaded, serialized operation of a three-stage pipeline to fetch instructions. FIG. 7 shows cycles 701-712 in the operation of a multithreaded, serialized, multiway instruction cache 550. During each cycle, one or more of the stages (IPF, IF, IS) are performed on one or more fetch words 352A-D and 362A-D by interleaved operation of threads 320 and 330.

The original fetch energy reduction scheme described with reference to FIG. 4 was based on a single threaded approach with 100% activity fetch access, energizing all tag and way data RAMs, until a way is selected in the third cycle of operation. It should be noted that, the primary difference between the multithreaded embodiment described with reference to FIG. 6 and the multithreaded embodiment described with reference to FIG. 7 is that instead of fetching tag RAMs 359, 369 and data RAMs in parallel, the embodiment of FIG. 7, when required, serially fetches tag RAMs 359, 369 and data RAMs.

In an embodiment of multithreaded multiway instruction cache 550, where instruction cache tag RAMs and data RAMs are serialized, access energy usage can be further reduced.

As with cycles 600, with multithreaded operation of fetch unit 104, using cycles 700, each thread 320, 330 processes independent address ranges and access requests. For example, as shown in FIG. 7, with thread resource 510A, thread 320 stores fetch words 352A-D from cache line 355 in instruction buffer 515A. With thread resource 510B, thread 330 stores fetch words 362A-D from cache line 365 in instruction buffer 515B.

Cycle 701: In contrast to cycle 601 from the description of FIG. 6 above, in cycle 701 of cycles 700, IPF 757 using thread 320 enables all tag RAMs 359 associated with cache line 355, but does not enable any data ways 210A-D. As noted above, this is in contrast to both cycles 401 and 601 above, where, at the first cycle, both tag RAMs 359 and data RAM ways 210A-D were enabled during the IPF stage.

Cycle 702: In this cycle, in IF 758 using thread 320, the enabled tag RAMs 359 are fetched. Though not an exact measurement, retrieving tag RAMS 359 is estimated to use 20% of possible access energy expenditure as compared to 100% for fetching both associated tag RAMs 359 and associated data RAMs.

Also in this cycle, in IPF 767 thread 330 enables all tag RAMs 369 associated with cache line 365. As with IPF 757 from cycle 701 above, no data RAMs are enabled during this cycle.

Cycle 703: In this cycle, in IS 359 using thread 320, enabled tag RAMs 359 are compared to received physical address 255 associated with fetch word 352A. Thereafter, for thread 320—now having a selected data RAM way, can proceed, requesting further fetches without requiring the enabling of tag RAMs 359 and additional ways during IPF stages.

Further in this cycle, in IF 768 using thread 330, the enabled tag RAMs 369 are fetched. Retrieving tag RAMS 359 is estimated to use 20% of possible access energy expenditure as compared to 100% for fetching both associated tag RAMs 369 and associated data RAMs.

Using the way selected by IS 759 described above, in IPF 710A using thread 320, a data RAM associated with fetch word 352A is enabled. As noted above, this contrasts with cycle 601 of FIG. 6 in that a selected way is provided to improve way prediction for all IPF stages of FIG. 7.

Cycle 704: In this cycle, in IS 769 using thread 330, enabled tag RAMs 369 are compared to received physical address 255 associated with fetch word 362A. Thereafter, for thread 330—now having a selected data RAM way, can proceed, requesting further fetches without requiring the enabling of tag RAMs 369 and additional ways during IPF stages.

Further in this cycle, in IF 712A using thread 320, the enabled data RAM from IPF 710A is fetched. Because selected way 285 was available for IPF 710A, IF 712A only needs to fetch a single way and no tag RAMs 359. Thus, in contrast to cycles 400 and 600 described with respective FIGS. 4 and 6 above, fetching fetch word 352A in cycles 700 is estimated to only use 20% of the possible access energy expenditure as compared to 100% in cycles 400 and 600.

Using the way selected by IS 769 described above, in IPF 720A using thread 330, a data RAM associated with fetch word 362A is enabled. As noted above, this contrasts with cycles 600 of FIG. 6 in that a selected way is provided to improve way prediction for all IPF stages of FIG. 7.

Cycle 705: In this cycle, in IS 715A using thread 330, enabled tag RAMs 369 are compared to received physical address 255 associated with fetch word 362A. Thereafter, for thread 330—now having a selected data RAM way, can proceed, requesting further fetches without requiring the enabling of tag RAMs 369 and additional ways during IPF stages.

Further in this cycle, in IF 712A using thread 320, the enabled data RAM from IPF 710A is fetched. Because selected way 285 was available for IPF 710A, IF 712A only needs to fetch a single way and no tag RAMs 359. Thus, in contrast to cycles 400 and 600 described with respective FIGS. 4 and 6 above, fetching fetch word 352A in cycles 700 is estimated to only use 20% of possible access energy expenditure as compared to 100% in cycles 400 and 600.

Using the way selected by IS 769 described above, in IPF 720A using thread 330, a data RAM associated with fetch word 362A is enabled. As noted above, this contrasts with cycles 600 of FIG. 6 in that a selected way is provided to improve way prediction for all IPF stages of FIG. 7.

Cycles 706 through 712: As would be appreciated by one having skill in the relevant art(s), given the description herein, as shown on FIG. 7, the remaining fetch words 352B-D and 362 B-D are processed by threads 320 and 330.

It should be noted that, the 20% access energy expenditure associated retrieving tag RAMs 359, 369 in cycle 702, IF 758 and cycle 703, IF 768 can be considered as respectively distributed across the four fetch word 352A-D, 362A-D fetches. The true access power expenditure depends on number of cache lines implemented, physical address bits used for tag comparison and process technology parameters. In an example, a typical 32K byte cache was observed to reach the 20% combined tag energy assumption used herein.

Thus, because each fetch word is estimated at 20% potential access energy expended, the total access energy per fetch word is 25%, accounting for both the data access power and ¼ of the tag access power (assuming the cache line has 4 fetch words and all of them are accessed). In contrast to the embodiments described with respect to FIGS. 4 and 6 (60% and 40% respectively), the FIG. 7 embodiment has a 25% estimate. In FIG. 7, to fetch tag RAMs 359, 369 in parallel, the total number of cycles 700 required is extended by two cycles to twelve (12). The FIG. 6 embodiment does not serialize the fetching of tag RAMs 359,369 and data RAMs, and lasts for ten (10) cycles with a higher access energy expenditure.

### Thread Priority

Interlacing multiple threads to serialize tag and way RAMs access as described with reference to FIG. 7, also provides means to control thread priority. In one embodiment, a high priority thread could, after its serialized tag access concluded and its way selection was calculated (IS 759 in cycle 703 and IS 769 in cycle 704), continuously fetch way data to quickly fill its instruction buffer.

In the example of FIG. 7, if thread 320 were considered higher priority than thread 330, after way selection for fetch words 352A-D is calculated in cycle 703 (IS 759), instead of interleaving the IPF, IF, IS phases between threads 320 and 330, an embodiment can continuously process fetch words 352A-D.

In another embodiment where thread priority is used to control aspects of embodiments, thread priority can be used to select between the multithreaded fetching approaches described with reference to FIGS. 6 and 7. As described above, as compared to the approach described with reference to FIG. 6, FIG. 7 describes an approach with a higher number of fetch cycles per fetch line and a lower energy expenditure. In an example, when both threads are of a relatively high priority, the approach of FIG. 6 is selected based on the lower number of fetch cycles per cache line as compared to the approach of FIG. 7.

In another embodiment, the approaches of FIG. 6 and FIG. 7 can be combined. In a multithreaded example of this approach, relatively high priority threads can use the approach described with reference to FIG. 6 and lower priority threads can use the approach described with reference to FIG. 7.

in an example of this combination approach, thread 320 is a relatively high priority thread, and thread 330 is a relatively low priority thread. This example starts with thread 320 performing the IPF 610A of fetch word 352A described with reference to FIG. 6. For the next cycle, while thread 320 continues with IF 612A, lower priority thread starts with the IPF 767 tag RAM retrieval for cache line 365, as described with reference to FIG. 7. One having skill in the relevant art(s), given the description herein, would appreciate how the two approaches continue on in this example with respective stages to retrieve fetch words from both cache lines 355 and 365. The end result is cache line 355 being fetched with less cycles per fetch and higher access energy expenditure than cache line 365.

### Way Prediction

As noted above with respect to FIGS. 2 and 4-7, some embodiments use way predictor 261 at instruction prepare to fetch (IPF) stage to identify one or more ways 210A-D from data RAM cache 262 for use by instruction fetch (IF) stage 270.

Different approaches to way prediction can be used by different embodiments. An example way predictor 261 as described in the embodiments of FIGS. 4, 6 and 7 above, for an initial fetch cycle enables a maximum number of ways associated with a particular cache line in the IPF stage. This approach is described above as using maximum potential access energy at this initial IPF stage. As also described above, once selected way 185 is available at a later cycle, this approach to way selection is able to predict a single way 210A with 100% accuracy. For example, stage IPF 610A from cycle 601 of FIG. 6 uses 100% potential access energy and, after selection of selected way 185 at IS 615A, IPF 610B only uses 20% potential access energy.

As noted above with the description of FIG. 3 above, this example way prediction is based on known characteristics of the data as cached. These known characteristics allow for a prediction of the placement of a fetch word based on the location of a previously fetched word. For example, as shown in FIG. 3, fetch words 352A-D, 362A-D are stored sequentially in respective cache lines 355, 365.

In another embodiment of way predictor 261, a micro-tag array (also termed a “micro-tag cache (MTC)” is used for way prediction during the IPF phase. Use of a micro-tag array for way selection by an embodiment can further reduce data cache access energy expenditure. The micro-tag stores base address data bits or base register data bits, offset data bits, a carry bit, and way selection data bits. When fetch word 352A is sought to be fetched, the instruction address is compared to data stored in the micro-tag array. If a micro-tag array hit occurs, the micro tag array generates a cache dataram enable signal. This signal enables only a single dataram of the cache. If a micro tag array hit occurs, a signal is also generated that disables the cache tagram.

An example a micro-tag array that can be used by embodiments is described in U.S. Pat. No. 7,650,465 ('465 patent) filed on Aug. 18, 2006, and issued on Jan. 19, 2010, entitled “Micro Tag Array Having Way Selection Bits for Reducing Data Cache Access Power” which is incorporated by reference herein in its entirety, although the invention is not limited to this example.

Micro-Tag Array with Multithreaded Fetch Operations

When a micro-tag array is used with multithreaded multiway instruction cache 550 from FIG. 5, each thread 320 and 330 have a micro-tag cache, e.g., respective cache way predictors 517A-B.

A Micro-tag array can be beneficially used at IPF 610A. In IPF 610A for example, instead of enabling four (4) cache ways 210A-D for fetching by IF 612A, a micro-tag array hit can allow only a single way 210A to be enabled. In addition, instead of enabling tag RAMs 359 for parallel fetching with ways 210A-D at IF 612A, a micro-tag array hit at IPF 610A allows an embodiment to avoid enabling tag RAMs 359. Thus, at cycle 601, using a micro-tag array allows the potential for significant access energy expenditure savings.

When a micro-tag cache hit occurs at IPF 610A, no update of the micro-tag array is required based on selected way 185. As noted above, based on a micro-tag array hit, only one way was enabled at IPF 610A and this way is fetched at IF 612A and selected at IS 615A without the use of tag RAMs 359.

When no micro-tag array hit occurs at IPF 610A, the operation of an embodiment proceeds as with cycle 601 from the description of FIG. 6 above. Ways 210A-D and tag RAMs 359 are enabled at IPF 610A and, at IF 612A, these enabled ways 210A-D and tag RAMs 359 are fetched. When using a micro-tag array, after tag RAMs 359 are used at TS 615A to select selected way 185, the micro-tag array is updated based on selected way 185. Using this updated micro-tag array, in IPF 610B, with results similar to the example described with FIG. 6 above, the updated micro-tag array provides the correct way 210A associated with fetch word 352A. As would be appreciated by one having skill in the relevant art(s), given the description herein, because threads 320 and 330, though interleaved, operate independently, regardless of whether thread 320 has a micro-tag array hit, thread 330 continues to operate as described with FIG. 6.

As described above, when used at an initial IPF stage, a micro-tag array hit can significantly reduce the access energy expenditure of the associated IF stage. Without a micro-tag array hit, the access energy expenditure is comparable to approaches using different way prediction approaches, e.g., the simple approach described above with reference to FIGS. 4, 6 and 7.

Micro-Tag Array with Multithreaded, Serialized Fetch Operations

A Micro-tag array can be beneficially used with multithreaded, serialized fetch operations described with reference to FIG. 7. At cycle 701, IPF 710A for example, instead of always enabling tag RAMs 359 for fetching at IF 758, micro-tag array can be checked for a hit first. With a micro-tag array hit, instead of enabling tag RAMs 359 for the later fetching of fetch words 352A-D, a single way 210A indicated by the micro-tag array can be enabled. Once this indicated way 210A is enabled at IPF 757, thread operation can skip to IF 712A, where the enabled way 210A is fetched. At IS 715A, the single way 210A is selected to be selected way 185.

Use of a micro-tag array with multithreaded serialized fetch operations can significantly reduce the access energy expenditure while increasing performance. This approach combines the potential benefits of skipping from IPF 757 to IF 722A with a micro-tag array hit, with the general benefits that can result from the multithreaded, serialized approach.

Without a micro-tag array hit, the access energy expenditure is comparable to access energy expenditures associated with different way prediction approaches, e.g., the less complex approach described above with reference to FIGS. 4, 6 and 7.

### Method 800

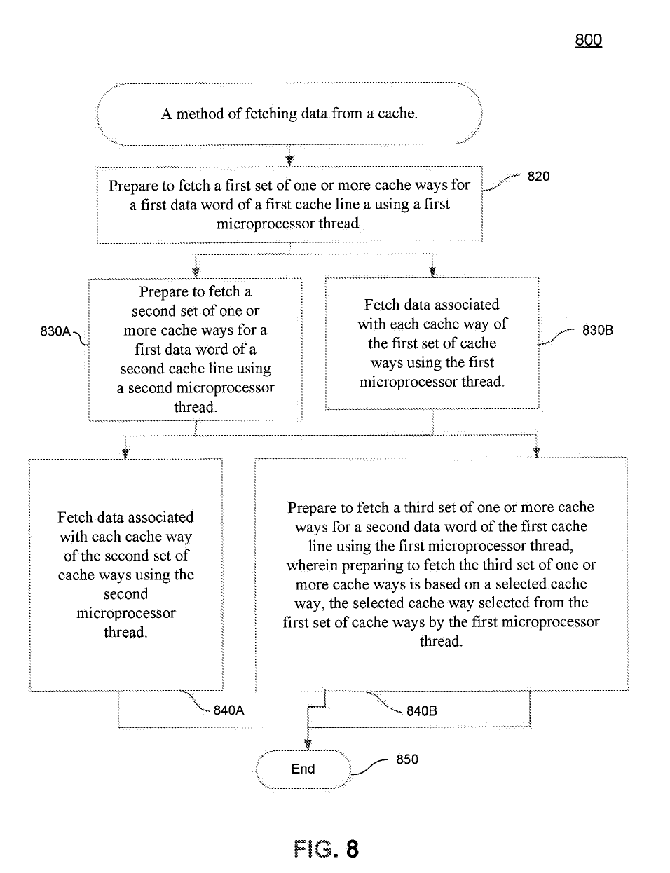

FIG. 8 is a flowchart illustrating a computer-implemented method of fetching data from a cache, according to an embodiment. The method begins at stage 820 with a first set of one or more cache ways for a first data word of a first cache line being prepared for fetching using a first microprocessor thread. For example, using thread 320, at cycle 601 of FIG. 6, IPF 610A prepares to fetch a first set of ways 210A-D from data RAM cache 262. These ways are associated with fetch word 352A from cache line 355. Once stage 810 is completed, the method moves to stage 820.

Stages 830A-B are performed in parallel. For example, the example stages below are performed at cycle 602 on FIG. 6. In stage 830A, a second set of one or more cache ways for a first data word of a second cache line is prepared to be fetched using a second microprocessor thread. For example, at cycle 602, using thread 330, IPF 620A prepares to fetch a second set of data ways 210A-D. These ways are associated with fetch word 362A from cache line 365. In stage 830B, data associated with each cache way of the first set of cache ways are fetched using the first microprocessor thread. For example, using thread 320, at cycle 602, IF 612A, the prepared first set of data ways 210A-D from cycle 601 are fetched. Once stages 830A-B are completed, the method moves to stages 840A-B.

Stages 840A-C are also performed in parallel. For example, the example stages below are performed at cycle 603 on FIG. 6. In stage 840A, data associated with each cache way of the second set of cache ways are fetched using the second microprocessor thread. For example, using thread 330, at cycle 603, IF 622A, the prepared second set of data ways 210A-D from cycle 602 are fetched.

In stage 840B, a third set of one or more cache ways for a second data word of the first cache line is prepared to be fetched using the first microprocessor thread. This third set of cache ways is prepared to be fetched based on a selected cache way, the selected cache way selected from the first set of cache ways by the first microprocessor thread. For example, at cycle 603, using thread 320, IPF 610B prepares to fetch a third set of ways 210A-. These ways are associated with fetch word 352B from cache line 355. IPF 610B is based on the selection of selected way 285 by IS 615A. Once stages 840A-B are completed, the method ends at stage 850.

While various embodiments of the present invention have been described above, it should be understood that they have been presented by way of example, and not limitation. It will be apparent to persons skilled in the relevant computer arts that various changes in form and detail can be made therein without departing from the spirit and scope of the invention. Furthermore, it should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in any known non-transitory computer usable medium including semiconductor, magnetic disk, optical disk (e.g., CD-ROM, DVD-ROM, etc.).

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence.

### Partial Address Compare Micro-Tag Array

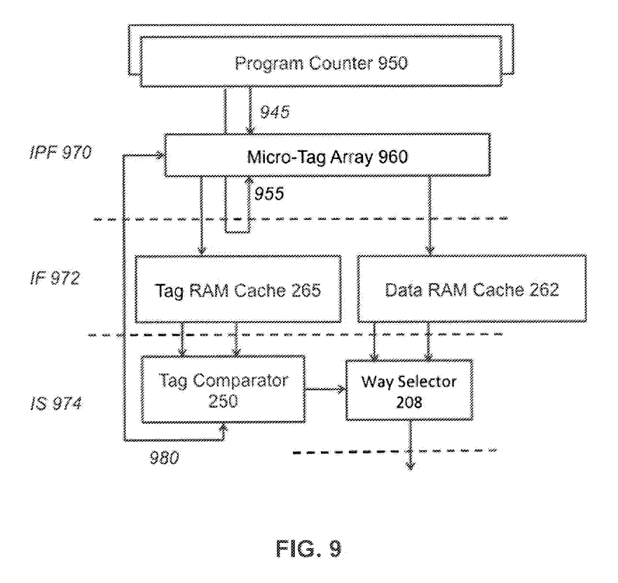

FIG. 9 shows multiway instruction cache 910. Multiway instruction cache 910 includes components used in four stages: instruction prepare to fetch stage (IPF) 970, instruction fetch stage (IF) 972, instruction selection stage (IS) 974 and instruction dispatch stage (IT) 976.

During IPF stage 970 micro-tag array 960 is used for way prediction. Based on this way prediction, preparations are made to fetch specific RAMs from data RAM cache 262 for ways 210A-D during IF stage 270. By comparing 945 a partial base address from program counter 950 micro-tag array 960 can identify one or more ways 210A-D in data RAM cache 262.

IF stage 972 includes data RAM cache 262 and tag RAMs from tag RAM cache 265. IS stage 974 includes way selector 208 coupled to tag comparator 250. Tag comparator 250 receives physical address 255. When a micro-tag array hit occurs using a partial address during the IPF stage, to verify 955 the enabled way, the full physical address 255 is compared to micro-tag array 960. Way selector 208 provides selected way 285 to instruction buffer 204. IT stage 976 includes dispatched instruction 295 from instruction buffer 204.

In an embodiment, with the examples described with respect to FIGS. 4, 6 and 7, a micro-tag array 960 can be used for way prediction that uses fewer bits than all the bits of the comparison address. This micro-tag array 960 will enable a way 210A based on a match based on a partial base address. This partial base address is a portion of the complete base address to be compared to the micro-tag array in a way similar to the implementation of micro-tag arrays described above.

When the portion of the base address data bits match the base address data bits stored in the base register of micro tag array 960, micro tag array 960 is configured to output an enable signal that enables a dataram of the cache specified by way selection data bits stored in the way selection register of the micro tag array.

An embodiment of the partial address compare micro-tag array uses lower order bits of the base address (after cache line address). As would be appreciated by one having skill in the relevant art(s), given the description herein, this approach is more likely to lead to a micro-tag array cache hit, but also more likely to lead to a mis-prediction. Instead of a single way resulting from a micro-tag array hit, multiple entries may match the submitted partial base address. In one approach to selecting from multiple ways found from a partial base address match, an embodiment only enables the most recently installed multi-tag array entry.

In an embodiment, because of the increased likelihood of mis-prediction, during the IF stage, when the address is available, a multi-tag array comparison of the full address is performed to check that the predicted way is not a mis-prediction. When a mis-prediction is detected, a replay of request to read all tags and datarams is performed.

### CONCLUSION

Embodiments described herein relate to a low power multiprocessor. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method of fetching data from a cache, comprising:
preparing to fetch a first set of one or more cache ways for a first data word of a first cache line a using a first microprocessor thread; and
in parallel:
preparing to fetch a second set of one or more cache ways for a first data word of a second cache line using a second microprocessor thread, and
fetching data associated with each cache way of the first set of cache ways using the first microprocessor thread;
in parallel:
fetching data associated with each cache way of the second set of cache ways using the second microprocessor thread, and
preparing to fetch a third set of one or more cache ways for a second data word of the first cache line using the first microprocessor thread, wherein preparing to fetch the third set of one or more cache ways is based on a selected cache way, the selected cache way selected from the first set of cache ways by the first microprocessor thread.

2. The method of claim 1, wherein preparing to fetch the third set of cache ways for the second data word in the first cache line using the first microprocessor thread comprises preparing to fetch a single cache way based on the selected cache way of the first set of cache ways.

3. The method of claim 1, wherein selecting the cache way of the first set of cache ways comprises selecting a cache way based on a received memory address.

4. The method of claim 1, wherein before preparing to fetch the first set of one or more cache ways, further comprising:
fetching a set of tag RAMs associated with the first cache line from a tag RAM cache; and
selecting a cache way for retrieving data words from the first cache line based on the fetched set of tag RAMs, wherein
preparing to fetch the first set of one or more cache ways for a first data word of a first cache line a using a first microprocessor thread comprises preparing to fetch the first set of cache ways based on the selected cache way based on the fetched set of tag RAMs.

5. The method of claim 4, wherein preparing to fetch the first set of one or more cache ways for a first data word of a first cache line a using a first microprocessor thread comprises preparing to fetch a single cache way based on the selected cache way based on the fetched set of tag RAMs.

6. The method of claim 4, wherein the fetching of tag RAMs and data associated with a cache way is serialized, with the fetching of tag RAMs completed before the commencement of fetching data associated with the cache way.

7. The method of claim 4, further comprising:
based on a priority of the first microprocessor thread, suspending operations of the second microprocessor thread; and
continuously processing the first cache line using the selected cache way based on the fetched set of tag RAMs.

8. The method of claim 4, wherein fetching a set of tag RAMs associated with the first cache line from a tag RAM cache comprises fetching a set of tag RAMs associated with the first cache line from a tag RAM cache using the first microprocessor thread, wherein the second microprocessor thread fetches tag RAMs and data RAMs associated with the second cache line in parallel.

9. The method of claim 8, wherein the second thread is a higher priority than the first thread.

10. A system for fetching data from a cache, comprising:
a multiway instruction cache configured to:
prepare to fetch a first set of one or more cache ways for a first data word of a first cache line a using a first microprocessor thread;
in parallel:
prepare to fetch a second set of one or more cache ways for a first data word of a second cache line using a second microprocessor thread, and
fetch data associated with each cache way of the first set of cache ways using the first microprocessor thread;
in parallel:
fetch data associated with each cache way of the second set of cache ways using the second microprocessor thread,
prepare to fetch a third set of one or more cache ways for a second data word of the first cache line using the first microprocessor thread, wherein preparing to fetch the third set of one or more cache ways is based on a selected cache way, the selected cache way selected from the first set of cache ways by the first microprocessor thread.

11. The system of claim 10, wherein preparing to fetch the third set of cache ways for the second data word in the first cache line using the first microprocessor thread comprises preparing to fetch a single cache way based on the selected cache way of the first set of cache ways.

12. The system of claim 10, wherein selecting the cache way of the first set of cache ways comprises selecting a cache way based on a received memory address.

13. The system of claim 10, wherein the multiway instruction cache, before preparing to fetch the first set of one or more cache ways, is further configured to:
fetch a set of tag RAMs associated with the first cache line from a tag RAM cache; and
select a cache way for retrieving data words from the first cache line based on the fetched set of tag RAMs, wherein
preparing to fetch the first set of one or more cache ways for a first data word of a first cache line a using a first microprocessor thread comprises preparing to fetch the first set of cache ways based on the selected cache way based on the fetched set of tag RAMs.

14. The system of claim 13, wherein preparing to fetch the first set of one or more cache ways for a first data word of a first cache line a using a first microprocessor thread comprises preparing to fetch a single cache way based on the selected cache way based on the fetched set of tag RAMs.

15. The system of claim 13, wherein the fetching of tag RAMs and data associated with a cache way is serialized, with the fetching of tag RAMs completed before the commencement of fetching data associated with the cache way.

16. The system of claim 13, wherein the multiway instruction cache is further configured to:
based on a priority of the first microprocessor thread, suspend operations of the second microprocessor thread; and
continuously process the first cache line using the selected cache way based on the fetched set of tag RAMs.

17. The system of claim 13, wherein fetching a set of tag RAMs associated with the first cache line from a tag RAM cache comprises fetching a set of tag RAMs associated with the first cache line from a tag RAM cache using the first microprocessor thread, wherein the second microprocessor thread fetches tag RAMs and data RAMs associated with the second cache line in parallel.

18. The method of claim 8, wherein the second thread is a higher priority than the first thread.

19. A computer processor comprising the components of claim 10.

20. A non-transitory computer readable storage medium having encoded thereon computer readable program code for generating a computer processor comprising:
a multiway instruction cache configured to:
prepare to fetch a first set of one or more cache ways for a first data word of a first cache line a using a first microprocessor thread;
in parallel:
prepare to fetch a second set of one or more cache ways for a first data word of a second cache line using a second microprocessor thread, and
fetch data associated with each cache way of the first set of cache ways using the first microprocessor thread;
in parallel:
fetch data associated with each cache way of the second set of cache ways using the second microprocessor thread,
prepare to fetch a third set of one or more cache ways for a second data word of the first cache line using the first microprocessor thread, wherein preparing to fetch the third set of one or more cache ways is based on a selected cache way, the selected cache way selected from the first set of cache ways by the first microprocessor thread.

21. A processor that enables a dataram based on a partial base address, comprising:
a cache that includes a plurality of datarams;
a processor pipeline register that is configured to store base address data bits;
a micro tag array, coupled to the cache and the processor pipeline register, wherein the micro tag array comprises:
a base register configured to store base address data bits,
a way selection register configured to store way selection data bits, wherein
when a portion of the base address data bits stored in the processor pipeline register match the base address data bits stored in the base register of the micro tag array, the micro tag array is configured to output an enable signal that enables a dataram of the cache specified by way selection data bits stored in the way selection register of the micro tag array, wherein the portion of the base address data bits has a fewer number of bits than the base address data bits stored in the processor pipeline; and
a fetch unit configured to fetch the enabled dataram specified by the way selection data bits.

22. The processor of claim 21, wherein the portion of the base address data bits are lower order data bits.

23. The processor of claim 21, further comprising, after the fetch unit fetches the enabled dataram, comparing the base address data bits to the fetched dataram.

24. The processor of claim 23, wherein, when the fetched dataram does not match the base address bits, enabling all data ways associated with the base address data bits.
